(19) United States
(12) Patent Application Publication
(10) Pub. No.: US 2017/0142684 A1
(43) Pub. Date: May 18, 2017

(54) METHOD AND APPARATUS FOR DETERMINING POSITION OF A USER EQUIPMENT

(71) Applicant: Samsung Electronics Co., Ltd., Suwon-si (KR)

(72) Inventors: Deepak BHATT, Bangalore (IN); Vinod Kumar GAMBHIR, Bangalore (IN)

(21) Appl. No.: 15/153,182

(22) Filed: May 12, 2016

(30) Foreign Application Priority Data
Nov. 17, 2015 (IN) 2420/CHE/2015

(51) Int. Cl. H04W 64/00; H04B 17/318; H04W 4/02

(52) U.S. Cl. CPC H04W 64/006; H04W 4/021; H04B 17/318

(57) ABSTRACT

A method and system for determining the position of a User Equipment (UE) is described. The method comprises determining signal strength of signals received from a plurality of signal sources in an area in which the UE is located; and estimating position information for a location of the UE in the area based on a position model and the signal strength.

### CROSS-REFERENCE TO RELATED APPLICATION(S)

This application claims priority under 35 U.S.C. §119(a) to an Indian Provisional Patent Application filed on May 12, 2015 in the Indian Intellectual Property Office and assigned Serial No. 2420/CHE/2015, and an Indian Complete Patent Application filed on Nov. 17, 2015 in the Indian Intellectual Property Office and assigned Serial No. 2420/CHE/2015, the entire contents of each of which are incorporated herein by reference.

### TECHNICAL FIELD

The present relate to a method and apparatus for positioning of User Equipment (UE).

### BACKGROUND

Positioning Systems are navigation systems that provide location information of a User Equipment such as a mobile phone, a tablet, a wearable device and the like in all weather conditions, anywhere. Generally outdoor positioning systems such as Global Positioning System (GPS), assisted GPS positioning, Cell-Identifier (ID) based positioning and so on are used by the UE to determine the location information. However, in environments, for example indoor environments, signals from such outdoor positioning systems may not be available or may be too weak for the UE to accurately determine position information of the UE. For example, in indoor environments such as shopping malls signals from a Global Positioning System (GPS) may be degraded due to multipath issues or may be unavailable due to signal penetration problems. In such scenarios, the accuracy or the availability of the location of the UE is hampered. In such environments where positioning does not work, fingerprinting methods are conventionally used to estimate the UE location. For example, Wi-Fi fingerprinting methods for location estimation to provide position information of the UE work in two phases. A training phase or offline phase includes generation of a radio map. The radio map generation involves signal strength data collection and estimation of corresponding distribution of signal strength. The collected data is usually stored in a position model server such as a server. An online phase includes capturing signature of real time Wi-Fi signal measurements (for example, incoming Received Signal Strength information (RSSI)) corresponding with Access Points (APs) of a Wi-Fi network in the area) at the UE. Further, these Wi-Fi signal measurements are matched statistically with the database or the radio map. To develop the database or the radio map, the area under consideration is divided into grids and at each grid point a total of approximately 60-100 RSSI samples are collected from all the available access points to get a fingerprint of RSSI (finger print data) at that grid point. The accuracy of the location estimation of the user also depends upon the resolution of the grid.

### SUMMARY

An aspect of the present disclosure is to provide a method and User Equipment (UE) for determining a position of the UE

Another aspect of the present disclosure is to provide a method for localized estimation of position information of a location of the UE within the area based on the position model.

The present disclosure provides a method for determining a position of a user equipment (UE), the method comprising: determining, by a location estimation module, signal strength of signals received from a plurality of signal sources in an area in which the UE is located; and estimating, by the location estimation module, position information for a location of the UE in the area based on a position model and the signal strength

The present disclosure provides an apparatus in a user equipment (UE) for determining position information of the UE in an area, wherein the UE comprises a location estimation module configured to: determine signal strength of signals received from a plurality of signal sources in an area in which the UE is located; and estimate position information for a location of the UE in the area based on a position model and the signal strength.

The present disclosure provides method of position model server for determining a position of a user equipment (UE), the method comprising: identifying a corresponding position model for an area in which the UE is located, wherein the position model includes one of an area level model, and a grid level model; transmitting the position model to the UE for estimating position information for a location of the UE in the areat.

The present disclosure provides an apparatus in a position model server for determining a position of a user equipment (UE) in an area, the position model server comprises a position model identification module configured to: identify a corresponding position model for an area in which the UE is located, wherein the position model includes one of an area level model, and a grid level model; and transmit the position model to the UE for estimating position information for a location of the UE in the area.

### BRIEF DESCRIPTION OF FIGURES

For a more complete understanding of the present disclosure and its advantages, reference is now made to the following description taken in conjunction with the accompanying drawings, in which like reference numerals represent like parts:

FIG. 1A illustrates a system for determining a position of a User Equipment (UE) in an area based on a position model received from a position model server, wherein the position model is an area level model, according to embodiments as disclosed herein;

FIG. 1B illustrates the system for determining the position of the UE in the area based on the position model received from the position model server, wherein the position model is a grid level model of the area, according to embodiments as disclosed herein;

FIG. 2 illustrates a plurality of components of the UE for determining the position of the UE in the area, according to embodiments as disclosed herein;

FIG. 3 illustrates a plurality of components of the position model server for determining the position of the UE in the area, according to embodiments as disclosed herein;

FIG. 4 is a flow diagram illustrating a method for determining the position of the UE in the area, according to embodiments as disclosed herein; and

FIG. 5 illustrates a computing environment implementing the method for determining the position of the UE in the area, according to embodiments as disclosed herein.

### DETAILED DESCRIPTION

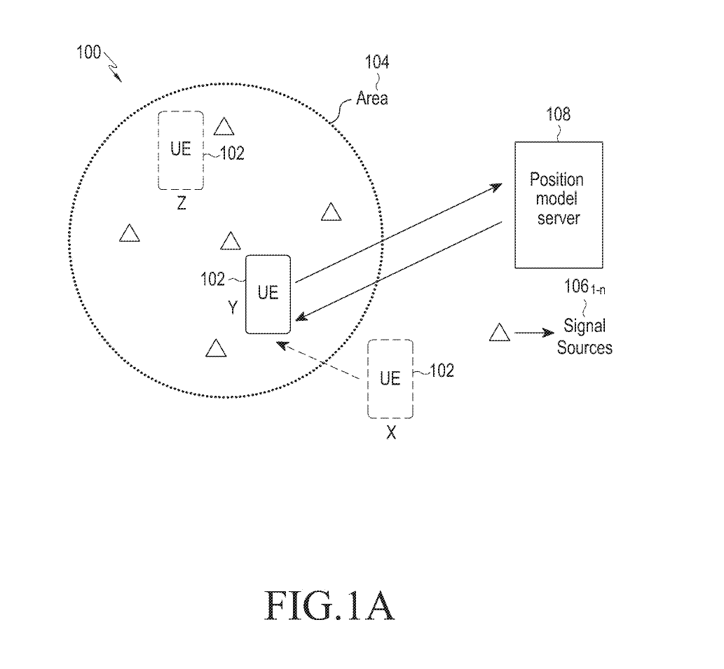

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system. Hereinafter, the present disclosure will be described in detail with reference to the accompanying drawings. The present disclosure may have various embodiments, while modifications and changes may be made therein. Therefore, the present disclosure will be described in conjunction with particular embodiments shown in the accompanying drawings. However, it should be understood that there is no intent to limit the present disclosure to the particular forms disclosed herein; rather, the present disclosure should be construed to cover all modifications, equivalents, and/or alternatives falling within the spirit and scope of the disclosure. In the description of the drawings, identical or similar reference numerals are used to designate identical or similar elements.

As used herein, the expression “include” or “may include” refers to the existence of a corresponding function, operation, or element, and does not exclude one or more additional functions, operations, or elements. Also, as used herein, the terms “include” and/or “have” should be construed to denote a certain feature, number, step, operation, element, component or a combination thereof, and should not be construed to exclude the existence or possible addition of one or more other features, numbers, steps, operations, elements, components, or combinations thereof.

Also, as used here, the expression “or” includes any or all combinations of words enumerated together. For example, the expression “A or B” may include A, may include B, or may include both A and B.

In the present disclosure, the expressions “a first”, “a second”, “the first”, “the second”, and the like may modify various elements, but the corresponding elements are not limited by these expressions. For example, the above expressions do not limit the sequence and/or importance of the corresponding elements. The above expressions may be used merely for the purpose of distinguishing one element from the other elements. For example, although both a first user device and a second user device are user devices, they indicate different user devices. For example, a first element may be termed a second element, and similarly, a second element may be termed a first element without departing from the scope of the present disclosure.

When an element is referred to as being “coupled” or “connected” to any other element, it should be understood that not only the element may be directly coupled or connected to the other element, but also a third element may be interposed therebetween. Contrarily, when an element is referred to as being “directly coupled” or “directly connected” to any other element, it should be understood that no element is interposed therebetween.

The terms used herein are used only to describe particular embodiments, and are not intended to limit the present disclosure. As used herein, the singular forms may include the plural forms as well, unless the context clearly indicates otherwise.

Unless defined otherwise, all terms used herein, including technical and scientific terms, have the same meaning as those commonly understood by a person of ordinary skill in the art to which the present disclosure pertains. Such terms as those defined in a generally used dictionary are to be interpreted to have the meaning equal to the contextual meaning in the relevant field of art, and are not to be interpreted to have ideal or excessively formal meaning unless clearly defined in the present disclosure.

Although embodiments of the present disclosure described below will be separated for the convenience of description, two or more embodiments may be combined so long as they do not conflict with each other.

A method and apparatus proposed in embodiments of the present disclosure may be applied to various communication systems, such as a long term evolution (LTE) mobile communication system, a LTE-advanced (LTE-A) mobile communication system, a high speed downlink packet access (HSDPA) mobile communication system, a high speed uplink packet access (HSUPA) mobile communication system, a 3^{rd} generation project partnership 2 (3GPP2) high rate packet data (HRPD) mobile communication system, a 3GPP2 wideband code division multiple access (WCDMA) mobile communication system, a 3GPP2 code division multiple access (CDMA) mobile communication system, an institute of electrical and electronics engineer (IEEE) 802.16m communication system, an evolved packet system (EPS), and a mobile Internet protocol (Mobile IP) system.

The embodiments herein achieve a method and a system for determining the position of a User Equipment (UE) in an area based on a position model received from a position model server. The position model can be an area level model of the area, or a grid level model of the area. The grid level model corresponds to a grid among a plurality of grids in the area, where the area is represented by a plurality of grid models corresponding to the plurality of grids. The position model, generated during offline phase and stored in a position model server can be provided to the UE prior to estimating position information for localizing the UE within the area. For example, the position model server can be a server maintaining a central data base or the like. Further, the method includes providing localized estimation (estimation at the UE end) of the position information corresponding to a location of the UE within the area. For example, the position information may include position coordinates or the like. The position information is estimated by processing real time signal strength of signals received by the UE at current location using a model estimation process of the position model received by the UE. The signals received by the UE correspond to a plurality of signal sources placed strategically in the area for determining the position of the UE. The signal sources include at least one of a wireless access point, a light source, a sound source, a magnetic source, a heat source or the like that are deployed in the area for determining the position of the UE.

The localized estimation of the position information at the UE end reduces reliance of the UE on the position model server for deriving the position information, thereby reducing latency in obtaining the users localization information. Further, reduces the space and computational complexity for deriving position information. Once the position information of the UE is obtained that is the UE is localized the position information can be used for applications such as location based services.

In an embodiment, the UE is a mobile phone, a tablet, a personal digital assistant, a laptop, a wearable device and any other UE capable of receiving and utilizing the position model for estimating position information.

Referring now to the drawings, and more particularly to FIGS. 1 through 5, where similar reference characters denote corresponding features consistently throughout the figures, there are shown embodiments.

FIG. 1A illustrates a system 100 for determining the position a UE 102 in an area 104 based on a position model received from a position model server 108, wherein the position model is an area level model, according to embodiments as disclosed herein.

In an embodiment, the system 100 includes the UE 102 roaming into the area 104. The area 104 is pre calibrated for estimation of position information of the UE within the area 104 that enables localizing the UE 102 without using an outdoor positioning system such as a Global Positioning System (GPS). For example area 104 can be an indoor environment of a shopping mall, or an indoor office environment where GPS signal is weak to localize or estimate the position information of the UE 102. The area 104 can include a plurality of signal sources 106₁₋ₙ which are placed strategically in the area 104. The plurality of sources 106₁₋ₙ may include access points (APs) of a Wi-Fi network for the area, Light Emitting Diodes (LEDs) installed in the area. Further, the plurality of sources 106₁₋ₙ may include any signal sources such as magnetic sources or heat sources used by positioning technology used in the area 104 that depends on determining the spatial/temporal variation of signal strengths measured.

Further, the system 100 includes a position model server 108 that stores the position model for the area. The position model is generated offline by pre calibrating the area. The position model is the area level model that provides mapping information of spatial variation of signal strength of the plurality of signal sources 106₁₋ₙ between geographic coordinates of an area. The offline generation of the position model includes capturing spatial variations of the signal strength (for example Received signal strength indication (RSSI)) using machine learning approaches. The captured variations are defined by a set of mathematical equations as obtained from trained machine learning model and represent the position model stored in the position model server 108. The position model is dynamically modified or updated at the position model server 108 to adapt to geographical variation of signal strength over time using adaptive learning based approaches such as machine learning or deep learning. For example, one or more signal sources may be repositioned, added to or removed from the plurality of signal sources 106₁₋ₙ. Thus, the changes in received signal strengths over time are captured to provide more accurate position information estimate in real time.

In real time, whenever the UE 102 is in the vicinity of the area 104, or enters the area 104 (for example, UE 102 at location X), the position model is received by the UE 102 for obtaining position information. In an embodiment, the position model can be received from a device in proximity of the UE 102 using Near Field Communication (NFC) technology, where the device is already been shared with the position model by the position model server 108. In an embodiment, the position model can be fetched by the UE 102 using one-time communication with the position model server 108. In an embodiment, the position model can be obtained using Bluetooth sharing from other devices in the vicinity, Wi-Fi broadcast through Wi-Fi device or access points in the area 104 and the like. The position model can be directly requested by the UE 102 or may be automatically provided to the UE 102 if the UE 102 is detected in the vicinity of the area 104. In an embodiment, the mechanism that can trigger the sharing of the position model with the UE 102 can be based on proximity of the UE 102 to the area 104 or may be based on one or more other factors predefined for the system 100. For example, during super market application usage by the user of the UE 102 for product location information, or scenarios wherein user needs to localize themselves needed for navigating to a particular place inside mall or location sharing to friends.

Further, the UE 102 can be configured to estimate the position information on receiving a request. The request may be from the user of the UE 102 or from a location based application running on the UE 102 or the like. The localized real time processing at the UE 102 for position information estimation includes detecting signal strength of signals received from the plurality of signal sources 106₁₋ₙ at the location (for example current location Y) of the UE 102. Further, the UE 102 can be configured to process the received signal strengths using the position model to obtain the position information corresponding to the current location. The UE 102 can be configured to pre-process the received signal strength of the signals to avoid any anomalies or outliers. The pre-processing involves ensuring the availability of all the signal sources considered during offline phase and applying an averaging technique on the received signal strength measurements to mitigate the effect of measurement noise, reflections etc. Further as UE 102 moves to a new location (location Z); the position information is updated based on the received signal strengths at the location Z. Once the UE 102 is localized, for example the position coordinates are obtained, the UE 102 can be provided with location based services. For example, based on the position information estimated by the UE 102 in a shopping mall, the user of the UE 102 may be provided with various offers available in all shops in his/her vicinity.

In an embodiment, the UE 102 can be configured to automatically turn on/off the position information estimation process depending upon the user mobility estimated using motion sensors. This reduces power consumed by the position estimation process and effectively improves the UE 102 performance and power backup. For example, if the user is stationary, the estimation of position information is halted since current location of the UE 102 would always be the previous location and no update is required.

In an embodiment, the UE 102 can be configured to seamlessly transition between GPS based position estimation and position estimation proposed by system 100 by detecting user's presence in a specific area. (For example, whether the user of the UE 102 is inside or outside the area 104). Mostly, outside the area the UE 102 receives the GPS signals to localize itself.

FIG. 1B illustrates the system 100 for determining the position the UE 102 in the area 104 based on the position model received from the position model server 108, wherein the position model is the grid level model within the area, according to embodiments as disclosed herein.

In an embodiment, the area 104 can be divided into plurality of grids such as grid 110a, 110b, 110c and 110d respectively. The grids can be identified based on geo fencing in the area 104. The grids may have any shape such as a square, a circular, a rectangular, a polygonal and the like. Whenever the UE 102 is in proximity area 104, the UE 102 can be configured to receive the position model. However, in the scenario where the area is divided into multiple grids defined by the geofences, the position model received by the UE 102 corresponds to the grid level model. The grid level model for each grid among the plurality of grids such as grid 110a, 110b, 110c and 110d respectively is generated offline and stored at the position model server 108. The offline generation of the position model (grid level model) includes capturing spatial variations of the signal strength (for example RSSI) for each grid in the area 104 using machine learning approaches. The captured variations for each grid are defined by a set of mathematical equations as obtained from trained machine learning model and represent the position model for each grid that is stored in the position model server 108. Thus, the area 104 is represented by the plurality of grid models corresponding to the plurality of grids. The grid level model provides mapping information of spatial variation of signal strength of the plurality of signal sources between geographic coordinates corresponding to the grid. Thus, the UE 102 can be configured to receive the grid level model corresponding to the grid 110a, where the grid 110a is a grid to which UE 102 has closest proximity (for example, grid corresponding to current location of the UE 102). The geofencing techniques can be used to track the user's (UE 102) position (or a movement across the plurality of grids 110a, 110b, 110c and 110d respectively) and an updated position model corresponding to the grid 110b can be received by the UE 102 if UE 102 crosses the grid 110a and enters the grid 110b. The grid can be inferred from the perimeter of the current position model UE 102 possesses. Thus, the UE 102 is not required to store or receive the complete area level model, rather requires a smaller grid level model. Thus, reduces memory space consumed and effectively reduces processing to estimate position information, along with reduced data usage required for receiving position model from the position model server 108 to UE 102. Further, this reduces time required to estimate the position information and enhances user experience by providing faster update on his/her position co ordinates.

As can be understood by a person skilled in the art, the system 100 described in FIG. 1A and FIG. 1B for a single area can be implemented for one or more other areas at various geographical locations. The position model server 108 maintains position models for each area that is pre calibrated offline. The UE 102 can receive the corresponding position model based on proximity of the UE 102 to a particular area among the plurality of areas pre calibrated and stored at the position model server 108.

FIGS. 1A and 1B show a limited overview of the system 100. The system 100 may include plurality of other components or modules or units that directly or indirectly interact with the components or modules shown in FIG. 1. However, other components are not described here for brevity. Further, the names of the components of the system 100 are illustrative and need not be construed as a limitation.

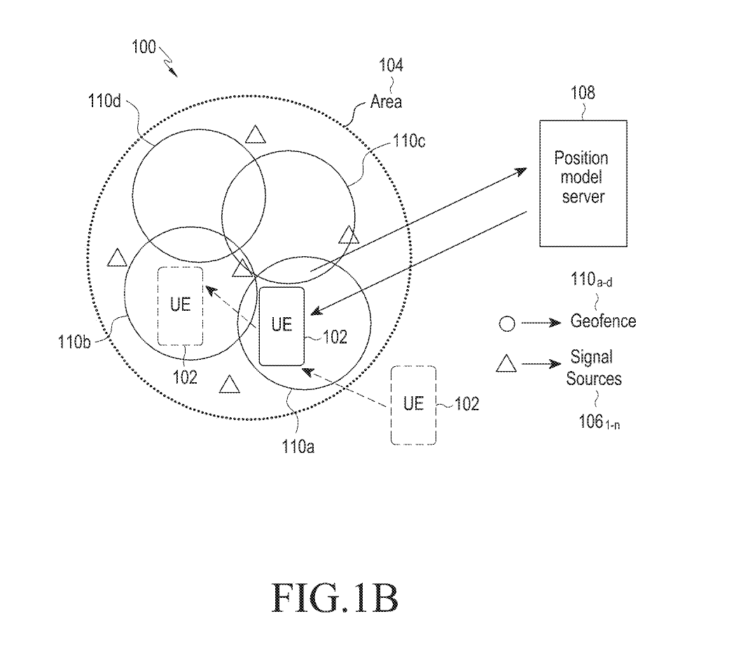

FIG. 2 illustrates a plurality of components of the UE 102 for determining the position of the UE 102 in the area 104, according to embodiments as disclosed herein.

Referring to FIG. 2, the UE 102 is illustrated in accordance with an embodiment of the present subject matter. In an embodiment, the UE 102 may include at least one processor 202, an input/output (I/O) interface 204 (herein a configurable user interface), a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the UE 102 to communicate with other devices. The I/O interface 204 may facilitate multiple communications within a wide variety of networks and protocol types, including wired networks, for example, Local Area Network (LAN), cable, etc., and wireless networks, such as Wide LAN, cellular, Device to Device (D2D) communication network, Wi-Fi networks, Light based positioning networks, and magnetic field based positioning networks, other positioning networks and so on.

The modules 208 include routines, programs, objects, components, data structures, etc., which perform particular tasks, functions or implement particular abstract data types. In one implementation, the modules 208 may include a location estimation module 210, further including a signal strength pre processing module 212 and the position model 214. Whenever the UE 102 approaches towards the area 104, the location estimation module 210 can be configured to receive the position model for the area 104. The position model is defined by the set of mathematical equations having input vector defined using received signal strength and the associated parameter values. The mathematical equations can be derived during offline phase using pre-calibrated radio map database. Extreme care is taken to avoid over fitting and under fitting in training phase. This improves the generalization capability of position model thereby improving overall positioning accuracy. For a Support Vector Machine (SVM), this is achieved by choosing the appropriate kernel and its parameter tuning whereas if chosen approach is Random Forest deciding the appropriate no of trees, its depth becomes critical to improve the position model accuracy. A general form is given below where x, y are the estimated geographical coordinates using α as obtained during training phase and the signal strength vector is given by equation 1 below:

(x,y)=f(α₁₋ₙ,106₁₋ₙ) (1)

In an embodiment, the position model can be the area level model of the area 104 if the position model server 108 possesses the area level model for the area 104.

In an embodiment, the position model can be the grid level model of the area, 104 if the position model server 108 has generated the plurality of grid level models corresponding to the plurality of grids in the area 104. Thus, if the area 104 is represented by plurality of grid models, then the position model received by the UE 102 corresponds to the grid level model corresponding to the grid to which the UE 102 has the closest proximity. Further, whenever the user enters the area 104 for the first time, the user (UE 102) localization information is obtained at the position model server 108. To localize the user (UE 102) for the first time in the area 104, the position model server 108 can be configured to collect the signal strengths as received at UE and localize user. This initial localization information can then be used by the position model server 108 to identify the position model (corresponding grid level model) to be sent to the UE 102 from the plurality of grid level models stored in the position model server 108. Further, the movement of the UE 102 across the plurality of grids 110a, 110b, 110c and 110d respectively can be tracked using geofencing techniques described in FIG. 1B and not repeated for brevity.

In an embodiment, the position model can be received from a device in proximity using Near Field Communication (NFC) technology, where the device is already shared with the position model by the position model server 108. In an embodiment, the position model can be fetched using one-time communication with the position model server 108. In an embodiment, the position model can be obtained using Bluetooth sharing from other UEs in the vicinity, Wi-Fi broadcast through Wi-Fi access points in the area 104 and the like. The position model can be directly requested by the UE 102 or may be automatically provided to the UE 102 if the UE 102 is detected in the vicinity of the area 104. In an embodiment, the mechanism that can trigger the sharing of the position model with the UE 102 based on proximity of the UE 102 to the area 104 or one or more other factors may be predefined for the system 100.

Further, whenever a request for position information is received by the location estimation module 210, then the location estimation module 210 can be configured to detect the signal strength of signals received from the plurality of signal sources 106₁₋ₙ at the location (current location) of the UE 102. For example, the signal strength received can be RSSI. Further, the location estimation module 210 can be configured to pre process the received signal strength using the signal strength pre processing module 212 to avoid any outliers or anomalies. The pre-processing involves ensuring the availability of all the signal sources considered during offline phase and applying an averaging technique on the received signal strength measurements to mitigate the effect of measurement noise, reflections etc. The preprocessed signal strength is provided to the position model. Further, the location estimation module 210 can be configured to estimate the position information for the current location of the UE 102 by processing the preprocessed signal strength using model estimation process based on the position model 214. The position model 214 includes a position estimator module, trained offline, to obtain the set of mathematical equations between the processed signal strengths from available signal sources to the corresponding geographic coordinates. A generalized form of mathematical relationship is as represented in equation 1. The location estimation module 210 can be configured to use the I/O interface(s) 204 for communication.

The modules 208 may include programs or coded instructions that supplement applications and functions of the UE 102. The data 216, amongst other things, serves as a repository for storing data processed, received, and generated by one or more of the modules 208. Further, the names of the other components and modules of the UE 102 are illustrative and need not be construed as a limitation.

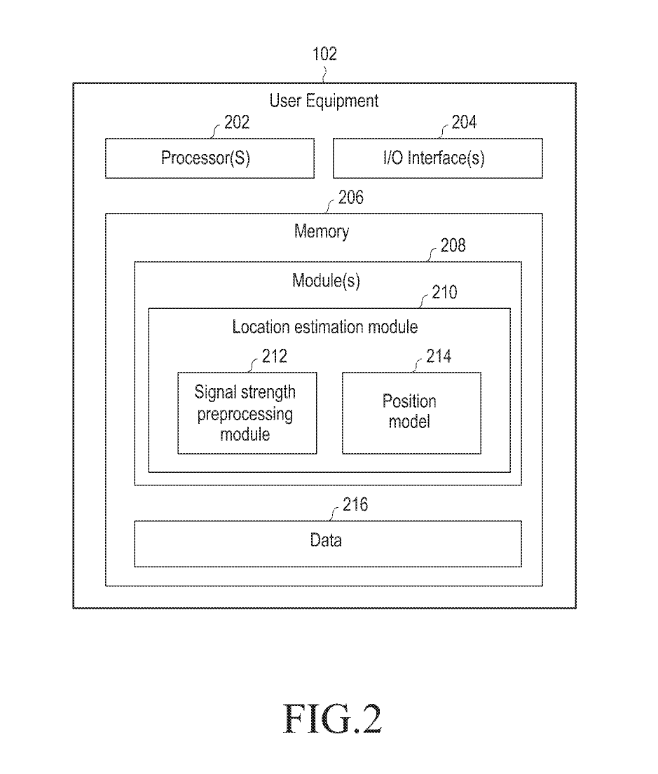

FIG. 3 illustrates a plurality of components of the position model server 108 for determining the position of the UE 102 in the area, according to embodiments as disclosed herein.

Referring to FIG. 3, the position model server 108 is illustrated in accordance with an embodiment of the present subject matter. In an embodiment, the position model server 108 may include at least one processor 302, an input/output (I/O) interface 304 (herein a configurable user interface), a memory 306. The at least one processor 302 may be implemented as one or more microprocessors, microcomputers, microcontrollers, digital signal processors, central processing units, state machines, logic circuitries, and/or any devices that manipulate signals based on operational instructions. Among other capabilities, the at least one processor 302 is configured to fetch and execute computer-readable instructions stored in the memory 306.

The I/O interface 304 may include a variety of software and hardware interfaces, for example, a web interface, a graphical user interface, and the like. The I/O interface 304 may allow the position model server 108 to communicate with other devices. The I/O interface 304 may facilitate multiple communications within a wide variety of networks and protocol types, including wired networks, for example, Local Area Network (LAN), cable, etc., and wireless networks, such as Wide LAN, cellular, D2D communication network, Wi-Fi networks and so on.

The modules 308 include routines, programs, objects, components, data structures, etc., which perform particular tasks, functions or implement particular abstract data types. In one implementation, the modules 308 may include a position model identification module 310 and position model 312 (for plurality of areas with the area level model or the grid level model). The position model identification module 310 can be configured to identify a corresponding position model from the position models 312 to be fetched or provided to the UE 102 depending on proximity of the UE 102 to area 104. The generation of the position model is performed, offline, by calibration of the area 104. The area level model provides mapping information of spatial variation of signal strength of the plurality of signal sources between geographic coordinates of the area. Further, the position model identification module 310 can be configured to provide the position model to the UE 102 for estimating the position information corresponding to the location of the UE 102 in the area 104.

In embodiment, where the area 104 is divided into plurality of grids, the position model server 108 can be configured to store plurality of grid models corresponding to plurality of grids of the area 104. Each grid level model provides mapping information of spatial variation of signal strength of the plurality of signal sources between geographic coordinates for the corresponding grid (grid 110a, 110b, 110c, and 110d respectively) in the area 104. The grids can be identified based on geo fencing in the area 104. The grids may have any shape such as a square, a circular, a rectangular, a polygonal and the like. Further, whenever the user enters the area 104 for the first time the user (UE 102) localization information is obtained at the position model server 108. To localize the user (UE 102) for the first time in the area 104, the position model server 108 can be configured to collect the signal strengths as received at UE and localize user. This initial localization information can then be used by the position model server 108 to identify the position model (corresponding grid level model) to be sent to the UE 102 from the plurality of grid level models stored in the position model server 108. The movement of the UE 102 across the plurality of grids 110a, 110b, 110c and 110d respectively can be tracked using geofencing techniques described in FIG. 1B and not repeated for brevity.

The position model (area level model or grid level model) can be directly provided to the UE 102 on a request from UE 102 or may be provided to one or more devices in the area 104. Further these devices can provide the position model to the UE using any of wireless communication technology such as Wi-Fi, blue tooth, NFC and the like. The position model generation module 310 can be configured to use the I/O interface (s) 304 for communication.

The position model stored in the position models 312 that are generated offline are updated/modified to adapt to geographical variation in the signal strength over time using learning based approaches. Thus, the position models 312 of the position model server 108 can be configured to receive, from the UE 102, the signal strength (RSSI) of any newly detected signal source and the existing signal source (plurality of signal sources 1061-n along with its location information if enabled at UE 102. The learning based approaches such as deep learning or machine learning can be then used by the position models 312 to modify the position model for an area while taking into effect the changes in the measurements arising due course of time and addition of new signal source and then store the updated position model in the position models 312. For example, one or more signal sources may be repositioned, added to or removed from the plurality of signal sources 106₁₋ₙ. Thus changes of the received signal strengths are captured to dynamically modify the position model at the position models 312 of the position model server 108 to provide more accurate position information estimate in real time.

The modules 308 may include programs or coded instructions that supplement applications and functions of the position model server 108. The data 314, amongst other things, serves as a repository for storing data processed, received, and generated by one or more of the modules 308. Further, the names of the other components and modules of the position model server 108 are illustrative and need not be construed as a limitation.

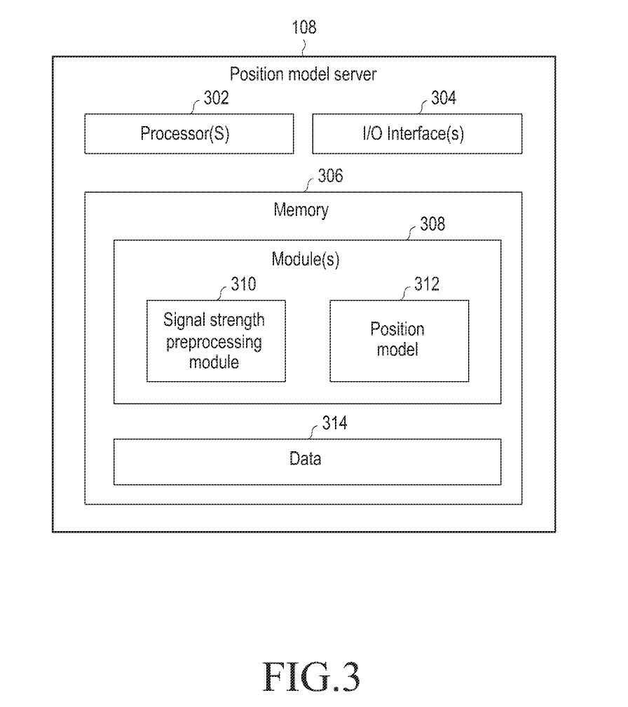

FIG. 4 is a flow diagram illustrating a method for determining the position of the UE in the area, according to embodiments as disclosed herein.

Whenever the UE 102 approaches closer towards area 104, then at step 402, the method 400 includes allowing the location estimation module 210 to receive the position model for the area 104. The position model enables the UE 102 to locally estimate the position information of the UE 102 within the area 104. In an embodiment, the position model can be received from a device in proximity using Near Field Communication (NFC) technology, where the device is already shared with the position model by the position model server 108. In an embodiment, the position model can be fetched using one-time communication with the position model server 108. In an embodiment, the position model can be obtained using Bluetooth sharing from other UEs in the vicinity, Wi-Fi broadcast through Wi-Fi access points in the area 104 and the like. The position model can be directly requested by the UE 102 or may be automatically provided to the UE 102 when the UE 102 is detected in the vicinity of the area 104. In an embodiment, the mechanism that can trigger the sharing of the position model with the UE 102 based on proximity of the UE 102 to the area 104 or one or more other factors may be predefined for the method 400.

In an embodiment, the position model can be the area level model of the area 104 if the position model server 108 stores a single area level model for the area 104.

In an embodiment, the position model can be the grid level model of the area if the position model server 108 stores the plurality of grid level models for the plurality of grids 106₁₋ₙ. The grids can be identified based on geo fencing in the area 104. The grids may have any shape such as square, circular, rectangular, polygonal and the like.

Further, whenever the request for position information is received from the user or the location based application running on the UE 102 or the like, then at step 404, the method 400 includes allowing the location estimation module 210 to detect the signal strength of signals received from the plurality of signal sources 106₁₋ₙ at the location (current location) of the UE 102. For example, the signal strength received can be RSSI. At step 406, the method 400 includes allowing the location estimation module 210 to preprocess the received signal strength using the signal strength preprocessing module 212 to avoid any anomalies or outliers. The preprocessed signal strength can be provided to the position model. The pre-processing involves ensuring the availability of all the signal sources considered during offline phase and applying an averaging technique on the received signal strength measurements to mitigate the effect of measurement noise, reflections etc. The method 400 includes allowing the location estimation module 210 to estimate the position information for the current location of the UE 102 by processing the preprocessed signal strength using model estimation based on the position model 210. The position model received from the position model server 108 can be dynamically modified at the position model server using learning based approaches.

The UE 102 can be configured to send, to the position model server 108, the signal strength (RSSI) of any newly detected signal source and the existing signal source (plurality of signal sources 106₁₋ₙ along with its location information, if enabled at UE 102. The learning based approaches such as deep learning or machine learning can be then used to modify the position model at the position model server 108 for an area while taking into effect the changes in the measurements arising due course of time and addition of new signal source and then store the updated position model in the position models 312.

The position information may be provided to the user in terms of position co ordinates, that can be further used by the user or the location based application running on the UE 102.

Further, whenever UE 102 moves to a new location the position information is updated based on the received signal strengths at the new location. In an embodiment, where the position model is the grid level model, the method 400 includes allowing the location estimation module 210 to receive the grid level model corresponding to the new location. The geo fencing techniques can be used to track the user's (UE 102) position (due to movement across the plurality of grids), for example, from grid 110a to grid 110b. The updated position model corresponding to the grid 110b can be received by the UE 102 if UE 102 crosses the grid 110a and enters the grid 110b.

The various actions in method 400 may be performed in the order presented, in a different order or simultaneously. Further, in some embodiments, some actions listed in FIG. 4 may be omitted.

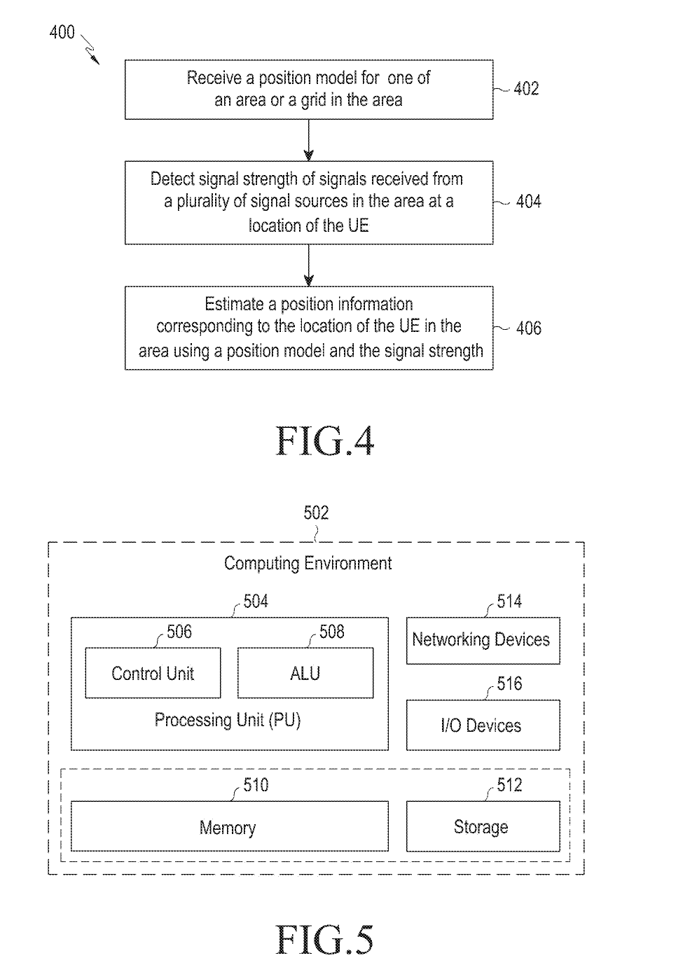

FIG. 5 illustrates a computing environment implementing the method for determining the position of the UE in the area, according to embodiments as disclosed herein.

As depicted, the computing environment 502 comprises at least one processing unit 504 that is equipped with a control unit 506 and an Arithmetic Logic Unit (ALU) 508, a memory 510, a storage unit 512, plurality of networking devices 514 and a plurality Input output (I/O) devices 516. The processing unit 504 is responsible for processing the instructions of the algorithm. The processing unit 504 receives commands from the control unit 506 in order to perform its processing. Further, any logical and arithmetic operations involved in the execution of the instructions are computed with the help of the ALU 508.

The overall computing environment 502 can be composed of multiple homogeneous and/or heterogeneous cores, multiple CPUs of different kinds, special media and other accelerators. The processing unit 504 is responsible for processing the instructions of the algorithm. Further, the plurality of processing units 504 may be located on a single chip or over multiple chips.

The algorithm comprising of instructions and codes required for the implementation are stored in either the memory unit 510 or the storage 512 or both. At the time of execution, the instructions may be fetched from the corresponding memory 510 and/or storage 512, and executed by the processing unit 504. In case of any hardware implementations various networking devices 514 or external I/O devices 516 may be connected to the computing environment to support the implementation through the networking unit and the I/O device unit.

The embodiments disclosed herein can be implemented through at least one software program running on at least one hardware device and performing network management functions to control the network elements. The network elements shown in FIG. 1 through FIG. 5 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for determining a position of a user equipment (UE), the method comprising:
determining, by a location estimation module, signal strength of signals received from a plurality of signal sources in an area in which the UE is located; and
estimating, by the location estimation module, position information for a location of the UE in the area based on a position model and the signal strength.

2. The method as claimed in claim 1,
wherein the position model is received from a position model server and the position model includes an area level model for the area, and
wherein the area level model includes mapping information of a spatial variation of the signal strength of the signals between geographic coordinates of the area.

3. The method as claimed in claim 1,
wherein the position model is received from a position model server and the position model includes a grid level model corresponding to a grid among a plurality of grids in the area, if the UE is in proximity of the grid,
wherein the grid level model includes mapping information of a spatial variation of the signal strength of the signals between geographic coordinates corresponding to the grid, and
wherein a movement of the UE across the plurality of grids is tracked based on geofencing techniques.

4. The method as claimed in claim 1, wherein the estimating of the position information comprises:
preprocessing the signal strength of the signals; and
estimating the position information for the location by processing the preprocessed signal strength based on a model estimation of the position model.

5. The method as in claim 1, wherein the position model is modified dynamically, by a position model server, to adapt to a geographical variation in the signal strength.

6. An apparatus in user equipment (UE) for determining position information of the UE in an area, wherein the apparatus comprises a location estimation module configured to:
determine signal strength of signals received from a plurality of signal sources in an area in which the UE is located, and
estimate position information for a location of the UE in the area based on a position model and the signal strength.

7. The apparatus as claimed in claim 6,
wherein the position model is received from a position model server and the position model includes an area level model for the area, and
wherein the area level model includes mapping information of a spatial variation of the signal strength of the signals between geographic coordinates of the area.

8. The apparatus as claimed in claim 6,
wherein the position model is received from a position model server and the position model includes a grid level model corresponding to a grid among a plurality of grids in the area, if the UE is in proximity of the grid,
wherein the grid level model includes mapping information of a spatial variation of the signal strength of the signals between geographic coordinates corresponding to the grid, and
wherein a movement of the UE across the plurality of grids is tracked based on geofencing techniques.

9. The apparatus as claimed in claim 6, wherein the location estimation module is configured to estimate the position information by:
preprocessing the signal strength of the signals; and
estimating the position information for the location by processing the preprocessed signal strength based on a model estimation of the position model.

10. The apparatus as claimed in claim 6, wherein the position model is modified dynamically, by a position model server, to adapt to a geographical variation in the signal strength.

11. A method of position model server for determining a position of a user equipment (UE), the method comprising:
identifying a corresponding position model for an area in which the UE is located, wherein the position model includes one of an area level model, and a grid level model; and
transmitting the position model to the UE for estimating position information for a location of the UE in the area.

12. The method as claimed in claim 11,
wherein the area level model includes mapping information of a spatial variation of the signal strength of the signals between geographic coordinates of the area.

13. The method as claimed in claim 11,
wherein the grid level model includes mapping information of a spatial variation of the signal strength of the signals between geographic coordinates corresponding to the grid, and
wherein a movement of the UE across the plurality of grids is tracked based on geofencing techniques.

14. The method as claimed in claim 11, wherein the position model is modified dynamically to adapt to a geographical variation in the signal strength based on learning based approaches.

15. An apparatus in a position model server for determining a position of a user equipment (UE) in an area, the apparatus comprises a position model identification module configured to:
identify a corresponding position model for an area in which the UE is located, wherein the position model includes one of an area level model, and a grid level model; and
transmit the position model to the UE for estimating position information for a location of the UE in the area.

16. The apparatus as claimed in claim 15,
wherein the area level model includes mapping information of a spatial variation of the signal strength of the signals between geographic coordinates of the area.

17. The apparatus as claimed in claim 15,
wherein the grid level model includes mapping information of a spatial variation of the signal strength of the signals between geographic coordinates corresponding to the grid, and
wherein a movement of the UE across the plurality of grids is tracked based on geofencing techniques.

18. The apparatus as claimed in claim 15, wherein the position model is modified dynamically to adapt to a geographical variation in the signal strength based on learning based approaches.
